(19) United States
(12) Patent Application Publication
(10) Pub. No.: US 2011/0088482 A1
(43) Pub. Date: Apr. 21, 2011

(54) Material for tensile and HCF tests for the testing of buildup welds and method

(76) Inventors: Raoul Costamagna, Mulheim an der Ruhr (DE); Birgit Grüger, Dortmund (DE); Michael Rollmann, Essen (DE); Joachim Skoczowsky, Leegebruch (DE)

(21) Appl. No.: 12/904,299

(22) Filed: Oct. 14, 2010

(30) Foreign Application Priority Data
Oct. 15, 2009 (EP) 09013056.8

(51) Int. Cl. G01N 3/08

(52) U.S. Cl. 73/850

(57) ABSTRACT

A material specimen is provided. The material specimen for tensile or HCF tests includes two welds arranged opposite one another on the specimen which do not touch. The welds are arranged symmetrically in relation to a plane or mirror symmetrically in relation to a longitudinal axis of the specimen which extends parallel to the line of effective force.

### CROSS REFERENCE TO RELATED APPLICATIONS

This application claims priority of European Patent Office application No. 09013056.8 EP filed Oct. 15, 2009, which is incorporated by reference herein in its entirety.

### FIELD OF INVENTION

The invention relates to a special specimen geometry for tensile and/or HCF tests for the testing of welds.

### BACKGROUND OF INVENTION

Components are often welded to one another or buildup welds are created. For later use, it must be tested for purposes of quality control whether the mechanical conditions of the welded component meet the requirements.

US 2006/0236765 A1 describes a specimen geometry in which a middle part of the specimen is completely formed by the weld.

U.S. Pat. No. 4,409,462 discloses a joining weld for the specimen geometry.

US 7,448,280 B2 describes a specimen geometry in which, in a middle region, the cross section is formed by a welded region and a substrate material.

### SUMMARY OF INVENTION

It is the object of the invention to improve the specimen geometry to allow faithful strength values to be deter mined.

The object is achieved by a specimen geometry according to the claims and a method according to the claims.

The subclaims list further advantageous measures, which can be combined with one another as desired in order to achieve further advantages.

In the case of buildup welds, the weakest link in this parallel arrangement of existing substrate material and welded-on material is generally the welding material.

Thus, if, as in US 2006/0236765 A1 or in U.S. Pat. No. 4,409,462, a middle region of a specimen geometry is formed only by welding material, the strength values of regions in which a buildup weld is present cannot be reproduced.

### BRIEF DESCRIPTION OF THE DRAWINGS

In the drawing:

FIG. 1 shows two schematic representations of a novel specimen geometry,

FIG. 2 shows part of a specimen geometry,

FIGS. 3 and 4 show a plan view of the specimen.

The description and the figures only represent exemplary embodiments of the invention.

### DETAILED DESCRIPTION OF INVENTION

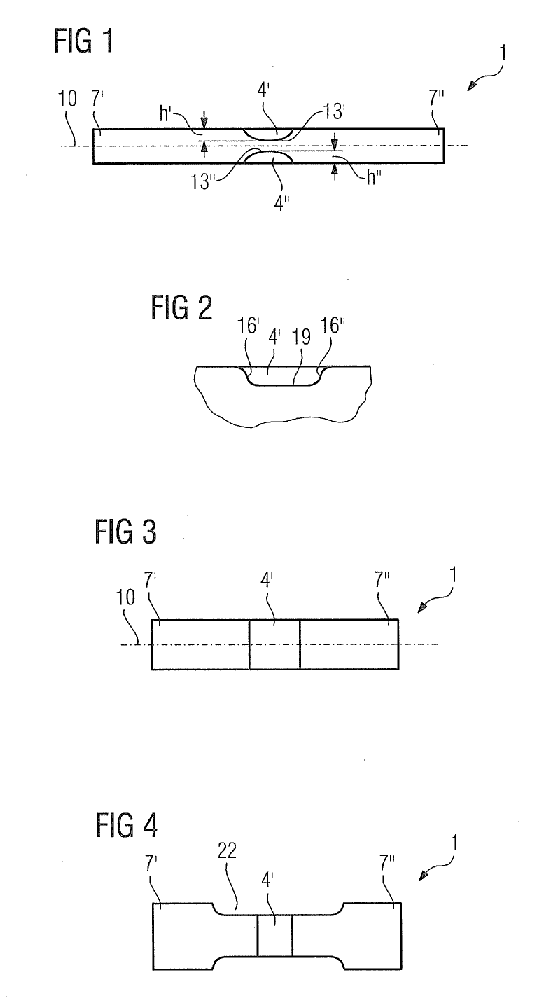

In FIG. 1, a side view of a specimen 1 is represented. The specimen 1 is restrained at the ends 7′, 7″ (not represented) and subjected to a force F, which extends parallel to a longitudinal axis 10 of the specimen 1.

The specimen geometry is substantially a flat specimen, that is to say cuboidal, in particular rectangular in cross section.

That is preferably 120 mm-150 mm length, 6 mm-10 mm thickness and 10 mm-20 mm width (FIGS. 3 and 4).

The cross section of the specimen 1 has a high aspect ratio along the longitudinal axis 10.

In the middle of the specimen 1 there are welds 4′, 4″ on both surfaces of the specimen 1.

Along the line of effective force F there are preferably depressions 13′, 13″ on both sides of the specimen 1, in which the welds 4′, 4″ are present.

The welds 4′, 4″ and depressions 13, 13′ preferably lie mirror-symmetrically opposite one another. The maximum depth h′, h″ of the weld 4′, 4″ is preferably the same on both sides. It is preferably 1 mm-2 mm.

The welds 4′, 4″ do not touch, however.

Similarly preferably, the cross section of the weld 4′, 4″ is the same size along the longitudinal axis 10, it being possible for the shape of the depressions 13′, 13″ to be formed in any way desired. In this exemplary embodiment in FIG. 1, it is shown as oval, but it may also have laterally rounded flanks 16′, 16″ and a middle region 19, which extends in a straight line (FIG. 2). Other shapes, such as without a straight extent in the middle 19, are conceivable.

FIG. 3 shows a view of a specimen 1 according to FIG. 1. The weld 4′, 4″ extends over the entire width of the specimen 1.

The specimen 1 may also have in the middle a diminution 22 (FIG. 4), within which the welds 4′, 4″ or the depressions 13′, 13″ are arranged.

Such specimen geometries may be used for tensile, high-cycle fatigue (HCF) tests or else for low-cycle fatigue (LCF) and other test methods. In particular, such specimen geometries are therefore suitable for components that are welded on both sides.

1.-8. (canceled)

9. A material specimen for tensile or high cycle fatigue (HCF) tests for the determination of material properties, comprising:
a material specimen including two opposite welds,
wherein the welds do not touch.

10. The specimen as claimed in claim 9,
wherein the welds are arranged symmetrically in relation to a plane or mirror-symmetrically in relation to a longitudinal axis of the material specimen, and
wherein the longitudinal axis extends parallel to a line of effective force.

11. The specimen as claimed in claim 9, wherein the welds are arranged in depressions.

12. The specimen as claimed in claim 9, wherein along the line of effective force, a contour of the welds includes curved flanks and/or a straight extent.

13. The specimen as claimed in claim 9, wherein the specimen is formed as substantially rectangular in cross section.

14. The specimen as claimed in claim 13, wherein the specimen includes dimensions, 120 mm-150 mm length, 6 mm-10 mm thickness, and 10 mm-20 mm width.

15. The specimen as claimed in claim 13, wherein the cross section of the specimen includes a high aspect ratio along the longitudinal axis.

16. The specimen as claimed in claim 9, wherein a cross section of the weld is a same size along the longitudinal axis.

17. The specimen as claimed in claim 9, wherein the welds are arranged in a region which is diminished in width in comparison with an end.

18. The specimen as claimed in claim 9, wherein a maximum depth of the weld is the same on both sides and lies in a range, 1 mm-2 mm.

19. The specimen as claimed in claim 9, wherein the weld extends over the entire width of the specimen.

20. A method for determining material properties of a specimen, comprising:
testing a specimen in a tensile, high cycle fatigue test or a low cycle fatigue test,
wherein the specimen, comprises:
two opposite welds which do not touch.
